(19) United States
(12) Patent Application Publication
(10) Pub. No.: US 2024/0348608 A1
(43) Pub. Date: Oct. 17, 2024

(54) Identity Proofing and Standardized Authorization

(71) Applicant: David Howell, Seattle, WA (US)

(72) Inventor: David Howell, Seattle, WA (US)

(21) Appl. No.: 18/636,053

(22) Filed: Apr. 15, 2024

Related U.S. Application Data
(60) Provisional application No. 63/459,395, filed on Apr. 14, 2023.

(51) Int. Cl. H04L 9/40

(52) U.S. Cl. CPC H04L 63/0884

(57) ABSTRACT

Identity proofing and standardized authorization that enables a managed service provider, or any external organization, to provide authentication and authorization services to a target organization based on verified credentials connected to decentralized identifiers. The managed service provider issues verified credentials to the target organization's entities and handles entity onboarding, device credential enrollment, device credential re-enrollment, entity offboarding and device credential disablement. The target organization uses the managed service provider's verified credentials as the primary authentication credential to authenticate entities and to access claims carried in the credential. The decentralized nature of the entity identifiers allows for a separation of identity management duties between the managed service and the target organization. Claim templates are also outlined that allow for the inclusion of standardized claims in the verified credential. These claim templates are improved over time based on learning from the ecosystem of organizations that rely on the service provider.

### BACKGROUND

Authentication is the process of verifying the identity of a user or computing device. This is typically done by requiring a user to provide a set of credentials, such as a username and password, which are then checked against a database of authorized entities. If the credentials match, the entity is granted access to protected resources. The main goal of authentication is to ensure that only authenticated entities can access sensitive data or perform certain actions. There are clear benefits in externalizing identity management for many organizations: Identity management is complex, the skills to do it effectively are hard to hire/acquire, and products offered to the market often do not include full identity lifecycle support. End user support is also challenging for organizations. However, externalizing identity management is difficult because most identity solutions for organizations are sold as platforms for them to manage internally, credentials authentication is tightly tied to centralized identifiers in the platform, and good solutions and processes do not exist to allow trusted identifiers exist external to the organization. Allowing organizations to externalize identity management from their internal operations securely and robustly would be of high benefit to many organizations because it would relieve them of the requirement to manage this complex lifecycle.

Authorization is the process of determining whether an authenticated entity has the necessary permissions to access a particular resource or perform a specific action. It's important to note that authorization must be done after authentication, as it's not possible to authorize an entity if its identity is not verified. Authorization role and claim set definition can become very complex in organizations. Roles and claim sets vary by application, are often application specific, and roles and claim sets can grow in an managed fashion becoming complex, overlapping, and convoluted. Simplifying role and claim set assignment can provide significant benefits for an organization.

### SUMMARY

The following presents a simplified summary of the subject innovation to provide a basic understanding of some aspects therein. This summary is not an extensive overview of the claimed subject matter. It is intended to neither identify key or critical elements of the claimed subject matter nor delineate the scope to the subject innovation. Its sole purpose is to present some concepts of the claimed subject matter in a simplified form as a prelude to the more detailed description that is presented later.

Described are techniques that allow a managed service provider or external organization to provide authentication and authorization lifecycle services to target organizations based on verified credentials, decentralized identifiers, and password-less authentication.

A managed service provider issues verified credentials attached to decentralized identifiers for a target organization's entities, which may be users, computing devices managed by users, or autonomous computing devices. The managed service provider handles entity and device onboarding, decentralized identifiers, issuing verified credentials, credential lifecycle management, and entity and credential offboarding. The target organization accepts credentials issued and verified by the managed service provider to authenticate their entities and to access claims carried in the verified credential. The target organization uses the managed service provider as an identity provider (IDP) or may rely on an internal identity solution that federates with the managed service provider. Entity state changes for enablement, disablement and role changes are communicated between the target organization and the managed service. The managed service provider may issue and verify the verified credentials directly or may broker this process through an external verified credential issuing and verification service. If it is brokering the process, the managed service provider handles configuring and requesting credentials from the issuing service for the entity, and handles requesting verification for the presentation of verified credentials from the entity.

A target organization can access claims in the verified identity for authorization purposes. Outlined is a technique for creating standardized claim templates that are surfaced by a service provider to a target organization to make it easier for the target organization to establish standards for authorization. A managed service provider's knowledge of standardized authorization roles or claim sets is improved by observing roles that are created by target organizations it manages. Over time the authorization choices offered by the managed service provider become more effective based on learning from the behavior of the population of target organizations it manages. Authorization templates may be applied to a target organization's entities resulting in cleaner more standardized authorization roles.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF DRAWINGS

FIG. 1 is a block and process diagram of a networked environment including Managed Service Provider and Target Organizations that rely on it for verified credentials and identifiers as well as flows that take place in an environment.

FIG. 2 describes an organization index holding organization identifiers, private key material, organizational infrastructure metadata such as identity provider solution and claim templates or a reference to claim templates that have been selected by an organization.

FIG. 3 is a block and process diagram that shows entity and credential lifecycle processes and the mechanisms by which Target Organization communicates with Managed Service Provider, and by which Managed Service Provider verifies the identity of an entity of Target Organization prior to issuing credentials and during lifecycle updates.

FIG. 4 describes a state diagram of entity and credential lifecycle operations.

FIG. 5 describes the basic format of the entity and linked device index where entities from organizations are stored along with their primary external identifier of record.

FIG. 6 describes a model for role and task standardization that is created by Managed Service Provider, selected by the Target Organization, and passed in verified credentials for application role/task mapping.

FIG. 7 describes verified credential presentation using the Managed Service Provider as an intermediary.

### DETAILED DESCRIPTION

Computing device can be ANY computing device, computer, mobile device, VR headset, etc. An entity is a subject that desires access to resources within an organization and may be a user, a computing device managed by a user, or an autonomous computing device.

A verified credential contains a set of one or more claims made by an issuer about a subject and is a tamper-evident credential whose authorship that can be cryptographically verified. Verifiable credentials can be used to build verifiable presentations, which can also be cryptographically verified.

A decentralized identifier (DID) is a globally unique reference linked to a DID document and is in the form did:<DID method>:<method-specific identifier>. The DID method is a reference to a specific distributed ledger or network and the method-specific identifier allows resolution of the DID within that reference. Given a DID, one can retrieve the referenced DID

Document. A DID Document contains information about an identity, such as its public keys. A DID Document also includes references to service endpoints, where the issuer can operate certain services.

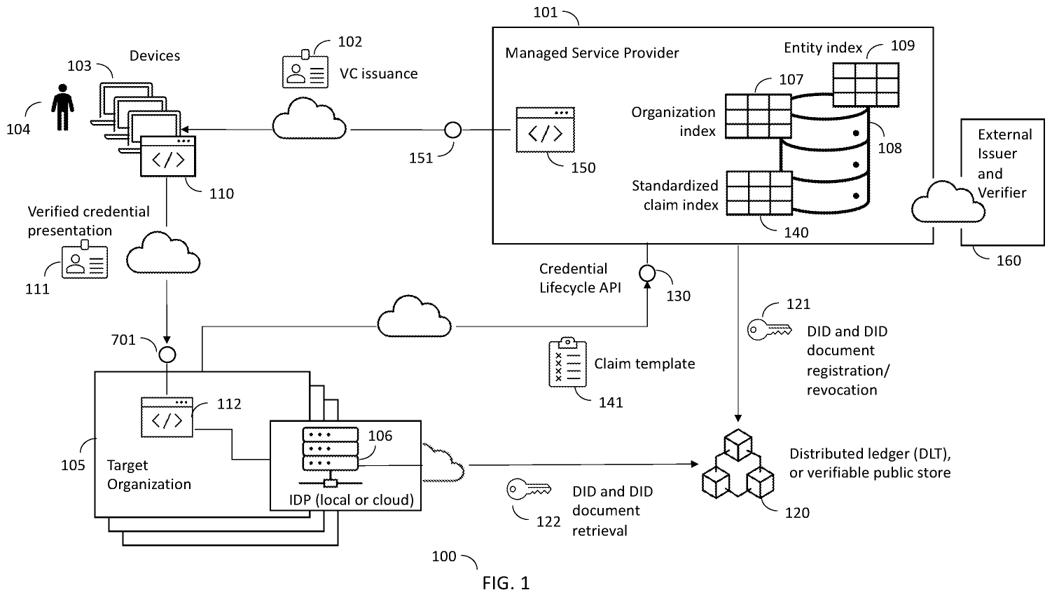

FIG. 1 [100] is a block and process diagram of a networked environment including Managed Service Provider (MSP) [101] and Target Organizations [105] relying on it for verified credentials (VC). [102]. At a high-level Managed Service Provider [101] is responsible for issuing verified credentials [102] or brokering the issuance of verified credentials [102] to computing devices [103] of entities [104] of Target Organizations [105].

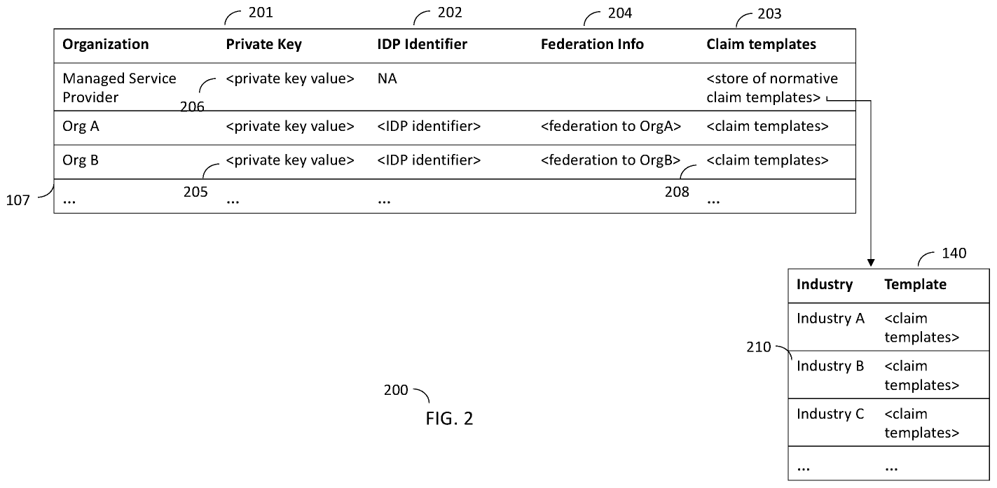

Managed Service Provider [101] creates, or calls an External Issuer and Verifier [106] hosted by another service provider to create, verified credentials [102] for computing devices [103] of entities [104] of Target Organization [105] and signs them with private signing key [205] created on behalf of Target Organization [105] or private key [206] owned by Managed Service Provider [101]. Private signing keys [205] [206] or an identifier linked to private signing keys [205] [206] is retained in organization index [107] stored securely and redundantly by Managed Service Provider [101] in datastore [108]. The organization index FIG. 2 [200] stores private signing [205] key or an identifier linked to private signing key [205] for each Target Organization [105] [201], the private signing key [206] or an identifier for private signing key [206] for Managed Service Provider [101], as well as metadata [202] for identity provider solution (IDP) [106] that Target Organization [105] relies on. The public key associated with private key [205] for Target Organization [105] or associated with private key [206] for Managed Service Provider [101] depending on which was chosen for issuer signing, which is used to verify the authenticity of the issuer of verified credential [102] is stored on public distributed ledger, or other verifiable public store [120] by Managed Service Provider [101] or the External Issuer and Verifier [160] it leverages using decentralized identifier (DID) and referenced DID document [121]. DID document [121] contains the information needed to verify signature of the signed verified credential as well as information to ensure that the credential is valid (not revoked or expired). If Target Organization [105] later decides that it wishes unenroll from Managed Service Provider [101], the Target Organization's private signing key [205] may be transferred to Target Organization [105] so that service will not be interrupted for its entities.

It should be noted that the operations to create, manage and decommission verified credential [102] might be undertaken directly by Managed Service Provider [101] or may be outsourced to one or more commercial platforms that provides these verifier or issuer services to Managed Service Provider [101]. In this case, this external issuer and verifier [160] and verifies credentials that are compatible with device authentication agents [110] that might be used by entities [104] of Target Organization [105]. External issuer and verifier [160] might also communicate directly with device authentication agent [110] in its communication flows.

Target Organization [105] configures their IDP [106] to accept verified credentials [102] issued and signed by Managed Service Provider [101] or enables federation [703] so that it trusts authentication assurances made by Managed Service Provider [101]. This IDP compatibility record may be kept in an organization index [107]. Before including the identity of computing device [103] in a verified credential [102], Managed Service Provider [101] needs to confirm the real identity of entity [104] that possesses or has organizational management responsibility for computing device [103]. The techniques for identity confirmation are described later in this document.

When computing device [103] presents its verified credential in a verified credential presentation [111] to application [112] at Target Organization [105], Target Organization's IDP [106] can confirm it was validly signed by both computing device [103] and trusted Managed Service Provider [101] by looking up publicly accessible DIDs and DID documents [122] from distributed ledger or verifiable public store [120] where the public keys for both the Managed Service Provider [101] and computing device [103] have been stored. IDP [106] of Target Organization [105] thus accepts credentials that have been issued and verified by Managed Service Provider [101] from computing device [103] for application access [112] within Target Organization [105]. This may require configuring IDP [106] to accept verified credentials signed by Managed Service Provider [101] as primary credentials.

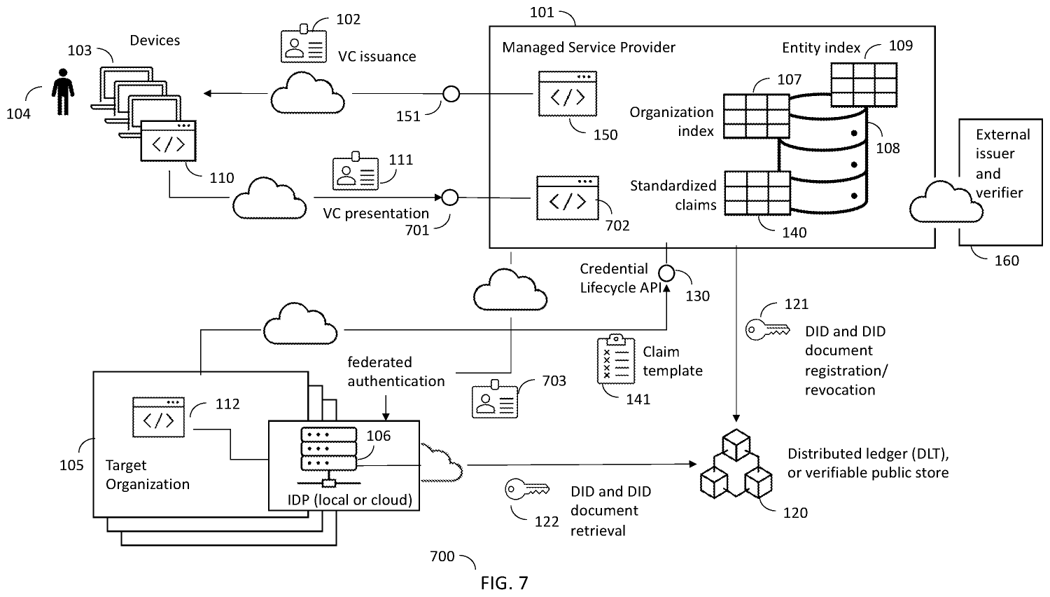

As an alternative authentication method, the Managed Service Provider [101] issues verified credentials [102] to entities [104]. An application [112] at the Target Organization [105] may direct an authentication requestion from computing device [103] of entity [104] to their internal Identity Provider [106] which may in turn make federation request [703] to the Managed Service Provider [101] for verification as shown in FIG. 7 [700]. Managed Service Provider [101] requires client [110] on computing device [103] of entity [104] to respond with a verified credential presentation [111], verifies this verified credential presentation [111] either internally or with the use of External Issuer and Verifier [160], and replies with the success result or failure result to the federation request [703] of Identity Provider [106] which returns the result to application [112]. In this way the Managed Service Provider [101] may take on the role of a federated identity provider for Identity Provider [106] by verifying entity [104] and computing device [103] verified credential presentations [111] on behalf of the Target Organization [105].

As an alternative to using a company specific key [205], verified credentials may be signed with a private key specific [206] to Managed Service Provider [101]. In this case, Target Organization's [105] IDP [106] is configured to accept credentials signed by Managed Service Provider private key [206] either directly or through federation. This might be beneficial for the case of a smaller company or where the company doesn't care to have offboarding portability for a private key [205] specific to the Target Organization [105].

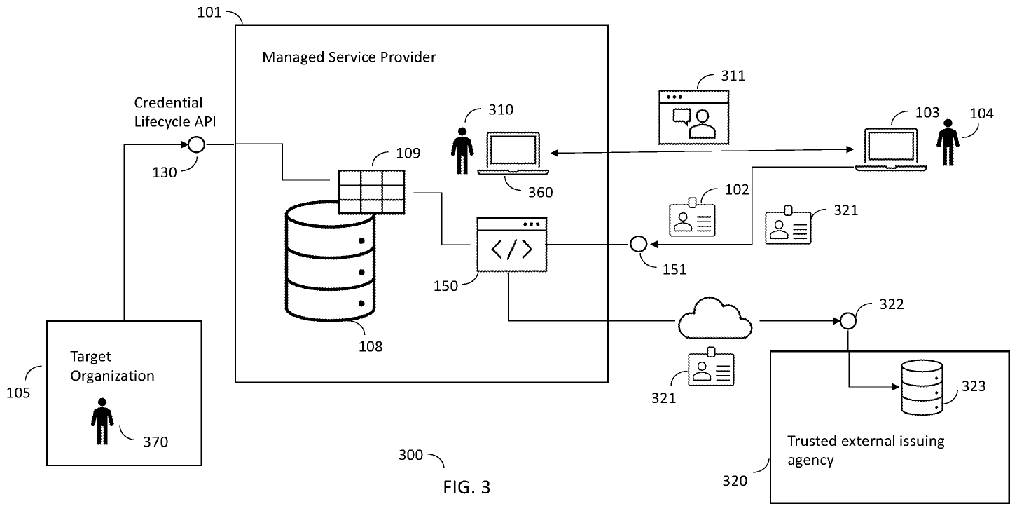

To effectively outsource credential lifecycle management for Target Organization [105], Managed Service Provider [101] must become aware of certain identity lifecycle events FIG. 3 [300] associated with entity [104] and computing devices [103] at Target Organization [105] and must be able to support the credential lifecycle of these entities [104] and computing devices [103]. Lifecycle operations include the onboarding [401] of entities [104] in Target Organization [105], the registration [402] of new entity computing devices [103] by entity [104], the revocation [403] of credentials and the deregistration [404] of entity [104] from Target Organization [105]. Managed Service Provider [101] must also be able to update entity claim information [410] and issue new verified credentials [102] and revoke [403] old credentials as a result of these updates [411]. This is not a fully exhaustive list of operations but is exemplary of the changes that may be supported.

FIG. 3 [300] is a block and process diagram that shows credential lifecycle flows by which Target Organization [105] communicates with Managed Service Provider [101], and by which Managed Service Provider [101] verifies the identity [104] of Target Organization [105] prior to issuing verified credentials [102].

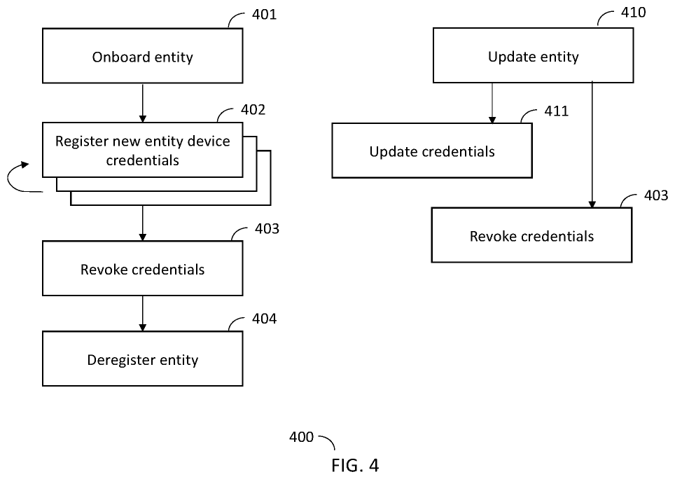

Referring to FIG. 3 [300], to support credential lifecycle management operations, Managed Service Provider [101] exposes a secure API endpoint [130] to Target Organizations [105] to communicate entity [104] lifecycle changes FIG. 4 [400]. Target Organization [105] may indicate when entity [104] has joined Target Organization [105], when entity [104] or computing device [103] is disallowed access to Target Organization [105], and when entity [104] has been removed from Target Organization [105]. As outlined in FIG. 4 [400], these translate into onboard entity [401], revoke credentials and deregister entity [404] states. The techniques described may also issue new credentials as entities [104] change or obtain new computing devices [103] [402]. Additional states may be invoked and there may be other lifecycle events issued from Target Organization [105] to Managed Service Provider [101] on lifecycle API [130]. The scope of this technique is intended to cover the full lifecycle of other identity [104] management lifecycle events that need to be coordinated between Target Organization [105] and Managed Service Provider [101] even though only some core lifecycle events are described above and in FIG. 4. [400].

This separation of duties is of huge benefit to Target Organization [105] as it may allow for specialization and separation of duties to be delegated to Managed Service Provider [101], removing helpdesk burden and its associated costs from Target Organization [105].

An entity [321] identifier allows Target Organization [105] and Managed Service Provider [101] to agree on the real-world identity of entity [104] that possesses or manages computing devices [103] is specified as part of the entity onboarding [401]. Once a record of an entity identifier [321] is obtained by Managed Service Provider [101] it can be used to verify entity's [104] real-world identity. Entity identifier [321] may be a publicly registered form of government or state identification such as a passport or driver's license that can be verified with an trusted external issuing agency [320]. Entity identifier [321] may also be a valid picture of the entity [104] that may be verified using image matching and a liveness check to ensure that entity [104] is physically present and matches the entity identifier [321] image. Verification may happen electronically but other methods may be employed. Entity identifier [321] is stored in entity [109] index by Managed Service Provider [101].

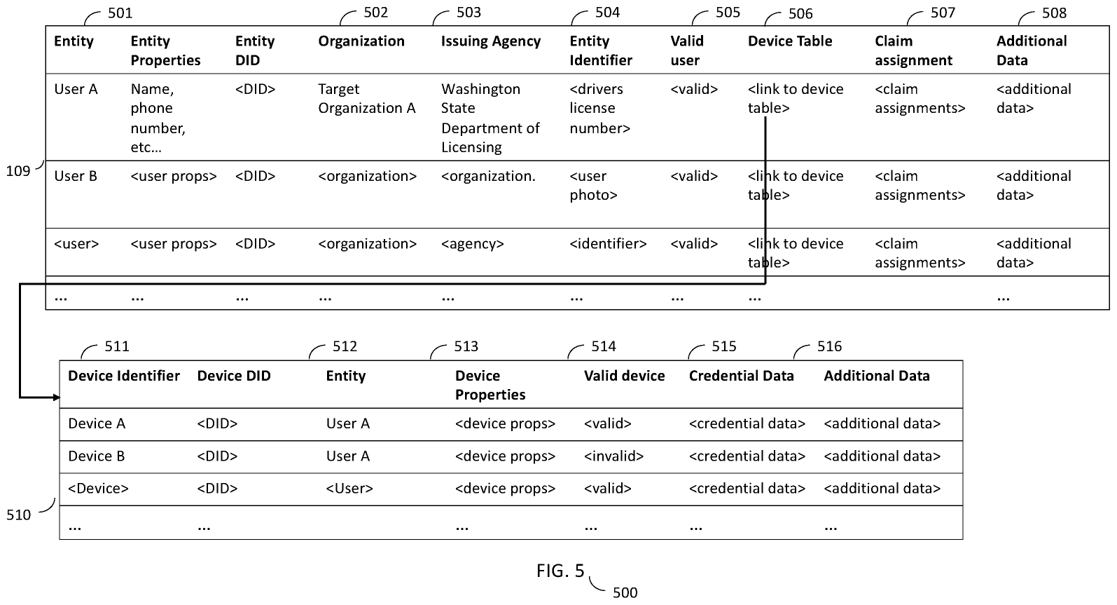

Detail of entity [109] index can be found in FIG. 5 [500]. Each index entry [501] may map an entity to their Target Organization [105], may contain a record of a trusted issuing agency [503] if applicable, and contains the record of a external agency identifier [504]. If an external agency is not used, entity identifier [321] may be a photograph of entity [104] that may be used in image analysis to ensure it matches entity [104]. The metadata, separation and layout of entity [104] index and device index [510] might be different from the example given in FIG. 5 [500].

As outlined in FIG. 3 [300], when entity [104] needs to obtain verified credential entity [104] may contact credential issuance interface [150] exposed by Managed Service Provider [101]. At a minimum this interface may be secured via SSL for Managed Service Provider [101]. This interface may be branded for Target Organization [105] and may be secured by a SSL certificate for Target Organization [105] so that it can be verified as a valid endpoint for Target Organization [105]. Entity [104] through computing device [103] submits a request for verified credential [102]. The submission request may require entity [104] to provide entity identifier [321]. Entity identifier [321] may contain a facial image. Entity identifier [321] may be checked to ensure it matches agency identifier [504] at trusted external issuing agency [320]. If API [322] is exposed by trusted external issuing agency [320] for verification, entity identifier [321] can be checked against API [322] for validation from trusted external issuing agency [320], which compares the entity identifier [321] against the trusted external issuing agency database [323]. This check of entity's [104] identity may also be used to ensure that entity identifier [321] has not been revoked by trusted external issuing agency [320].

As an alternative, through provisioning interface [130], Target Organization [105] may provision entity [104] in Managed Service Provider [101] with an image of entity [104]. This image may be used for electronic facial comparison of the stored image against entity [104] prior to issuing the credential. The verification process may also check for “liveness” that ensures entity [104] is present with computing device [103], a living person, and interacting with computing device [103]. The comparison and liveness check may take place on either credential issuance [102] or verified credential [111] presentation [701] either to Target Organization [105] or to Managed Service Provider [101] in the federation case.

During verification the video presence of entity [104] may be compared using facial recognition software against the facial image in entity identifier [321]. Based on the steps of facial detection, feature extraction, feature comparison and finally a matching decision, it can be determined if entity [104] is the legitimate entity [104] represented in entity identifier [321]. The recognition software may also perform a “liveness check” that ensures that entity [104] is present with computing device [103], a living person, and interacting with computing device [103]. If there is uncertainty in the matching decision, an in-person video conversation may be initiated between personnel [310] from Managed Service Provider [101] and entity [104] to confirm entity's [104] identity.

If entity [104] is determined to be no longer valid by Target Organization [105], for example in the case of employee termination or suspension, Target Organization [105] may issue a deregister entity request [404], as described in FIG. 4 [400], to Managed Service Provider [101] through credential lifecycle API [130]. On receiving this request, Managed Service Provider [101] can mark entity [104] as invalid in the entity index [109] [505] and can revoke verified credentials [102] issued to their computing devices [103]. After revocation, verified credential presentations [111] based on verified credentials [102] previously issued to computing devices [103] managed by entity [104] will no longer be accepted as a valid. Entity [104] may be identified by a DID, by an entity [321] identifier or by any other agreed identifier shared between Target Organization [105] and Managed Service Provider [101].

Managed Service Provider [101] may create a credential expiry date for verified credentials [102] so that a computing device [103] that obtains them is required to periodically refresh verified credentials [102]. This process of “credential rolling” is managed by Managed Service Provider [101] removes this administrative burden from Target Organization [105].

Note, that although the description of techniques above has focused on entity [104] devices, they apply to the credentialing any computing device [103] that may need a verified credential [102] for access to Target Organization [105]. For example, an administrator of a daemon process or server process are similarly considered computing devices [103] and can go through flows of onboarding, verifying the identity of a entity [104] who is responsible for managing them, and after confirmation of entity's [104] identity, verified credentials [102] can be issued to computing device [103]. In addition, entity [104] requiring authentication can be any subject that has a need for accessing protected resources located at Target Organization [105] and may be a user entity, computing entity, or any other entity.

The preceding part of the description has covered authentication and the enrollment of verified credentials [102] on computing devices [103] in a way that allows a separation of duties and responsibilities between Managed Service Provider [101] and Target Organization [105] leveraging decentralized identifiers [121]. A verified credential [102] can carry additional claims [620] about entity [104] that are confirmed by the issuer of credential [102]. We now describe techniques for the establishment of standardized claims [620] for authorization of computing devices [103] that makes the process of determining what authorization standards to adopt much easier for Target Organization [105]. This implementation of authorization standards is not required by the verified credentials flows for authentication described above but can be utilized to create a complete authentication and authorization solution.

Typically, solution providers of applications and identity platforms leave role and task assignment for roles-based authorization and task-based authorization up the organization that has purchased the solution. Since organizations do not always have authorization expertise, they can inadvertently create overlapping, confusing and/or extraneous roles or tasks, especially when trying to create custom roles. Also, their scope of understanding of suitable roles and tasks are often limited to their specific organizational experience. This lack of knowledge and standardization is an opportunity for an external managed service provider to standardize and suggest more optimal role definitions and assignments for organizations. What follows is a description of techniques for standardizing role and task assignments.

Verified credential [102] can carry with it claims [620] that may outline properties of an entity [104], which may be a user, described by credential [102]. These properties can be anything related to entity [104]. For example, claims [620] may outline which department the entity [104] belongs to, which roles entity [104] is expected to take on as part of their responsibilities, and which specific tasks that entity [104] might be allowed to undertake. Specifically, claims [620] may be used to guide permissible actions in applications [112] within Target Organization [105].

Because Managed Service Provider [101] is exposed to many Target Organizations [105] and entities [104], it may build a set of best practices for claims [620] that may be applied to entities that need to access resources. In this case, claims [620] are a set of properties outlining roles or tasks entity [104] might be granted. Across organizations, there is a standardization of job types and roles, even if it is not immediately apparent to each organization. Most organizations have a sales function, a finance function, many have a product management function and an engineering function. There are standardized job templates within industries and across industries and standard roles and tasks available to these templates; however, this information is not readily available across different organizations.

As part of the credential lifecycle API [130], Managed Service Provider [101] exposes a set of standardized claim templates [141] to Target Organization [105]. These can be accessed at either entity onboarding [401] or through an update entity [410] interaction.

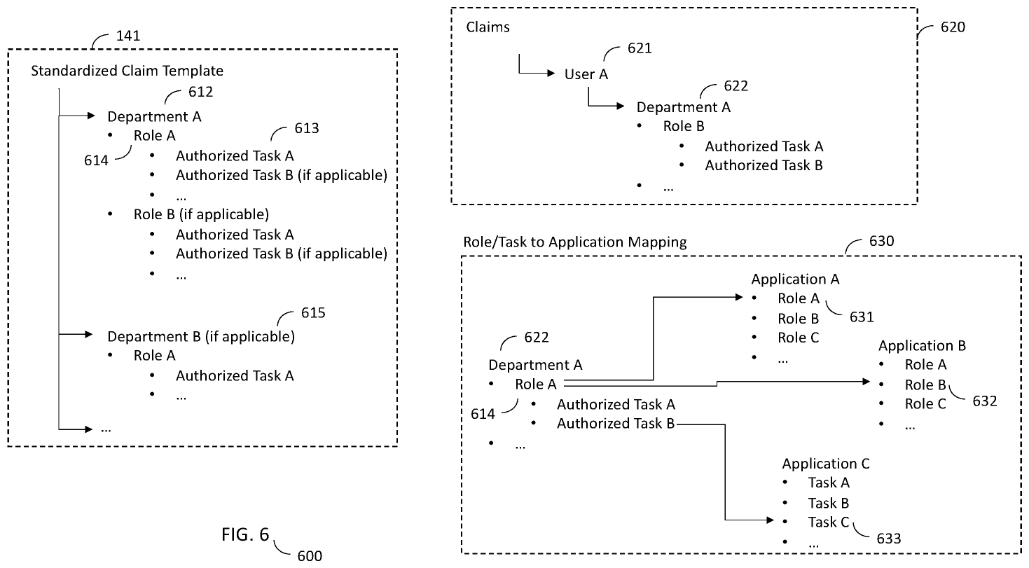

FIG. 6 [600] describes detail around a standardized claim template [141]. The picture is representational and might be implemented multiple ways and there might be multiple standardized claim templates [141] made available by Managed Service Provider [101]. Standardized claim template [141] outlines options for claim assignment to entities [104] chosen by Target Organization [105]. The templates provide normative, standardized, descriptions of organizational departments [612], roles within departments [614] and authorized tasks that might be performed by roles [613]. This simplicity of expression to makes it easier for Target Organization [105] to understand what roles and tasks they might want to assign to entity [104]. The hierarchal construction of departments, roles and/or authorized tasks in FIG. 6 [600] is for communication convenience and does not require that roles [614] or authorized tasks [613] be formally organized this way in the template.

Standardized claim templates [141] are stored at Managed Service Provider [101] in standardized claim index [140]. Administrator [370] at Target Organization [105] selects from standardized claim templates [141] what department, role and/or task assignments it wants to standardize for its entities [104] and these choices are stored Target Organization [105] in organization index [107] [203]. Multiple of these template choices can be stored for a given Target Organization [105]. Managed Service Provider [101] can also recommend which claim templates [140] might be most applicable to Target Organization [105] based on the industry [210] Target Organization [105] a member of. The goal here is to simplify and recommend default roles and tasks for Target Organization [105] and to reduce complexity and reinvention of roles at Target Organization [105].

When entity [104] is provisioned [401] or updated [410], Target Organization's Administrator [370] can specify which of their configured claim templates [208] should be assigned to entity [104]. This claim assignment is recorded in entity index [104] [507]. On issuing verified credential [102] claims [620] are recorded in verified credential [102]. If desired claims [620] for entity [104] later change due to an organizational, role or task change, they can be updated by Target Organization's [105] Administrator [370] through the credential lifecycle API [130]. This update causes them to be updated in entity index [109] [410] and new claims [620] to be issued in verified credentials [102] going forward. Outstanding verified credentials [102] can be revoked from DID document [121] so that entity [104] must update their verified credentials to a new verified credential [102] containing new claims [620].

When entity [104] uses their verified credential [102] to create a verified credential presentation [111], their associated role and task properties as expressed in claims [620] are attached to their verified credential presentation [111]. The description of claims [620] is for illustrative purposes and does not define the actual encoding in the verified credential [102] or the verified credential presentation [111]. After authentication at Target Organization [105], these claims are available to applications [112] in Target Organization [105].

Because roles differ among applications, claims [620] connected to entity [104] can be mapped to application-specific roles [630] within Target Organization [105]. Referring to FIG. 6 [600], standard role [614] defined by Managed Service Provider [101] is mapped by Target Organization [105] to application specific roles [631] [632] for Target Organization's [105] internal applications [112]. This is typically done within an enterprise directory by mapping a directory group or role to an application role using an interface or API provided by the application. Managed Service Provider's [101] standardized role [614] defined for entity [104] might map to different application specific roles [631] [632] depending on the application in question. Managed Service Provider [101] can provide tooling and guidance to ease the mapping between standardized roles [614] and task assignments [613] and well known publicly available application specific roles [631] [632] and task assignments [633].

Managed Service Provider's [101] knowledge of standardized authorization roles and tasks is based on industry practice but can also be informed by observing roles that are created by Target Organizations [105]. Over time authorization templates [141] offered by Managed Service Provider [101] become better curated based on learning input from a population of Target Organizations [105]. Computer machine learning techniques may be applied to improve this curation of suggested authorization templates [141]. This technique of offering standards for customer selection, and for having refined learning based on experience, allows for the establishment of strong standards for authorization.

1. A system to provide identity credential management, the system comprising:
a processor;
a first network interface that provides verified credentials that can be verified by strong encryption proofs;
a second network interface for validating verified presentations of these credentials;
a third network interface to receive entity lifecycle events from an organization for its entities;
a fourth network interface for SAML, OAUTH or other federated protocol communication with the organization relying on the system for verified credential issuance and verified credential presentation verification;
a first store containing instructions, that, when executed by the processor, creates verifiable credentials or uses an external issuer and verifier to create the verifiable credentials for the entity, or directs a client device of the entity to the external issuer and verifier to create verifiable credentials;
a second store containing instructions, that, when executed by the processor verifies the verifiable credential presentation or uses the external issuer and verifier to verify the verifiable credential presentations for the entity or directs a client device of the entity to the external issuer and verifier to verify the verifiable credential presentations; a third store for storing information used to identify an entity for which a credential is to be created;
a fourth store to store additional property information for the entity.

2. The system of claim 1, wherein an assertion about the identity of the entity managed by the system is stored in the verified credential issued by the system to that entity and signed with a private key associated with the entity's organization or a private key associated with the system.

3. The system of claim 2, wherein the private key associated with the entity's organization can be transferred to the organization in a case of the organization wishing to remove itself from the system.

4. The system of claim 1, wherein a state of the credential issued to the entity using the system is known to be valid or invalid and the state is updated on a public ledger or other verifiable public store.

5. The system of claim 1, wherein a credential can be verified by the system on behalf of the organization and a result of the verification returned to the organization.

6. The system of claim 1, wherein entity lifecycle events and role changes within the organization are captured through a network interface between the organization and the system.

7. The system of claim 1, wherein metadata exists for the entities using the system containing an entity identifier supplied by the entity's organization that can be uniquely verified against the entity.

8. The system of claim 7 wherein the entity identifier supplied by the entity's organization can be uniquely verified against a trusted external issuing agency.

9. The system of claim 8, wherein the system is networked to the trusted external issuing agency so that it can verify the entity identifier presented to it by the entity with the trusted external issuing agency.

10. The system of claim 7, wherein the identity of the entity is a stored image of the entity and is validated by the system using facial recognition algorithms or recognition software against the entity identifier.

11. The system of claim 7, wherein the identity of the entity is verified against the entity identifier by a video feed that ensures the entity is live and present.

12. The system of claim 1, wherein the identity of the entity is verified through a live video session with a service representative of the system.

13. The system of claim 1, wherein the system can be custom branded for the organization of which the entity is a member.

14. The system of claim 1, wherein assertions about properties related to the entity are stored in the verified credentials issued by the system and these properties can specify departments, roles, tasks or other properties of the entity.

15. The system of claim 14, wherein if the properties specified for the entity change, there is a communication interface by which the organization communicates these changes to the system and the system revokes any previously verified credentials and issues new verified credentials containing the property changes for the entity.

16. The system of claim 14, wherein standardized templates of entity departments, roles, tasks or other properties are stored as templates by the organization that uses the system.

17. The system of claim 16, wherein the standardized templates can be organized by industry group.

18. The system of claim 16, wherein the organization can choose and customize from the standardized templates organization specific departments, roles, tasks or property templates to assign to the organization's entities, and these choices are recorded in the system.

19. The system of claim 16, wherein the organization can pick specific departments, roles, tasks, or other properties from prestored templates for that organization and assign them to the entity.

20. The system of claim 16 wherein the system uses algorithms or machine learning to evaluate choices by the organization in department, role and task assignment and uses those choices to improve the standard templates offered to other organizations.

21. A method that enables an identity credential managed service, compromising:
issuing a signed verifiable credential identifying an entity on behalf of an organization;
verifying an entity's verifiable credential presentation on behalf of the organization; and returning a verification result to the organization;
receiving identity lifecycle events about the entity from the organization.

22. The method of claim 21, further comprising revoking the verified credential issued to the entity based on lifecycle events from the organization that indicate that the verified credential should be revoked.

23. The method of claim 21, further comprising including role and task properties related to the entity in the verified credential of the entity.

24. The method of claim 21, further comprising creating a role or task template for commonly used organizational roles and tasks.

25. The method of claim 24, further comprising allowing the organization to pick the role or task template to associate with their entities, to assign the template to a particular entity in their organization, or to create a custom template for their entities.

26. The method of claim 25, further comprising of refining the role or task templates based on using algorithms or machine learning to evaluate choices by the organization in department, role or task assignment and using those choices to improve template standards offered to other organizations.
